(19) United States
(12) Patent Application Publication
(10) Pub. No.: US 2025/0376542 A1
(43) Pub. Date: Dec. 11, 2025

(54) LOW-POLYMERIZATION-DEGREE POLYGLUCOSE AND PREPARATION METHOD THEREOF

(71) Applicant: SHANDONG BAILONG CHUANGYUAN BIO-TECH CO., LTD, Shandong (CN)

(72) Inventors: Hongjian ZHUO, Shandong (CN); Wenping YU, Shandong (CN); Deshan ZHANG, Shandong (CN); Mingzhan ZHANG, Shandong (CN); Qian DU, Shandong (CN); Xiqiong LIU, Shandong (CN); Yue LIU, Shandong (CN); Xingjing ZHANG, Shandong (CN); Shuangshuang LIU, Shandong (CN)

(73) Assignee: SHANDONG BAILONG CHUANGYUAN BIO-TECH CO., LTD, Shandong (CN)

(21) Appl. No.: 18/879,849

(22) PCT Filed: Jan. 29, 2024
(86) PCT No.: PCT/CN2024/074472

§ 371 Date: Dec. 30, 2024

(30) Foreign Application Priority Data
Jan. 30, 2023 (CN) 202310044337.1

(51) Int. Cl. C08B 37/00

(52) U.S. Cl. CPC C08B 37/0006

(57) ABSTRACT

The present disclosure provides low-polymerization-degree polyglucose and preparation method thereof, and belongs to the technical field of dietary fibers. The present disclosure concerns with mixing maltose, glucose and sorbitol to carry out polymerization reaction to obtain a polymerization reaction product; subjecting the polymerization reaction product to decolorization, ion exchange, concentration and drying sequentially to obtain low-polymerization-degree polyglucose; the weight ratio of maltose, glucose and sorbitol is (40-50):(40-50):(0-10). The low-polymerization-degree polyglucose provided by the present disclosure has an average polymerization degree of 6-8, a 5-hydroxymethylfurfural content of ≤0.01%, a color of ≤30, a sweet taste and no bitter taste of polyglucose.

### CROSS-REFERENCE TO RELATED APPLICATIONS

The present application is based on and claims priority from Chinese patent application No. 202310044337.1 filed on Jan. 30, 2023, the content of which is incorporated herein by reference.

### TECHNICAL FIELD

The present disclosure relates to the technical field of dietary fibers, and particularly relates to low-polymerization-degree polyglucose and preparation method thereof.

### BACKGROUND ART

Polyglucose is a new type of water-soluble dietary fiber obtained by polymerization reaction of glucose and sorbitol under acidic and vacuum conditions. It has been approved by more than 50 countries as a health food ingredient and is widely used in the production of fortified fiber foods. After consumption, it has the function of maintaining gastrointestinal patency. Polyglucose binds to clear bile acids in the body, significantly reducing serum cholesterol and making it easier to feel full. It can also significantly lower postprandial blood sugar levels, etc.

High-temperature polycondensation method for preparing oligosaccharide is a method for preparing oligosaccharide by mixing and reacting monomers, a catalyst and the like under the conditions of high temperature and high pressure. The specific method is as follows: food grade glucose, sorbitol, citric acid are mixed in a ratio of approximately 89:10:1, and then subjected to a three-step process of melt polycondensation, solution neutralization, and product decolorization under high-temperature and vacuum conditions. The reaction temperature is between 130° C. and 295° C. The reaction time varies depending on temperature and vacuum degree. The higher the temperature and vacuum degree, the shorter the reaction time, usually around several tens of hours. This method is simple and efficient, and most of the glucan sold on the market is produced using this method.

The glucan produced by this method has a molecular weight distribution that is not easy to control, and a high polymerization degree; high-temperature and long-time reaction produces pigment, and the product is yellow or red in color, has a special bitter taste, poor processing performance, and cannot meet the growing demand of consumers.

### Contents of the Invention

In view of this, the purpose of the present disclosure is to provide a low-polymerization-degree polyglucose and preparation method thereof. The low-polymerization-degree polyglucose provided by the present disclosure has an average polymerization degree of 6-8, a 5-hydroxymethylfurfural content of ≤0.01%, a color of ≤ 30, a sweet taste and no bitter taste of polyglucose.

In order to achieve the above purpose, the present disclosure provides the following technical solution:

The present disclosure provides a method for preparing low-polymerization-degree polyglucose, comprising the following steps:
mixing maltose, glucose and sorbitol, and then adding an acidic catalyst to carry out polymerization reaction to obtain a polymerization reaction product;
subjecting the polymerization reaction product to decolorization, ion exchange, concentration and drying sequentially to obtain low-polymerization-degree polyglucose;
the weight ratio of maltose, glucose and sorbitol is (40-50):(40-50):(0-10).

Preferably, the polymerization reaction is carried out under vacuum conditions, with a vacuum degree of −0.085 to −0.1 MPa.

Preferably, the temperature of the polymerization reaction is 120° C.-140° C., and the time of the polymerization reaction is 60 min-120 min.

Preferably, the acidic catalyst is citric acid, phosphoric acid, hydrochloric acid, nitric acid, oxalic acid, malic acid, fumaric acid, acetic acid or lactic acid, and the preferred acidic catalyst is citric acid or phosphoric acid.

The present disclosure also provides low-polymerization-degree polyglucose prepared by the above method, wherein the low-polymerization-degree polyglucose has an average polymerization degree of 6-8, a 5-hydroxymethylfurfural content of ≤0.01%, a color of ≤30, a sweet taste and no bitter taste of polyglucose.

Beneficial technical effects: the present disclosure provides low-polymerization-degree polyglucose and preparation method thereof. The present disclosure concerns with mixing maltose, glucose and sorbitol to carry out polymerization reaction to obtain a polymerization reaction product; subjecting the polymerization reaction product to decolorization, ion exchange, concentration and drying sequentially to obtain low-polymerization-degree polyglucose; the weight ratio of maltose, glucose and sorbitol is (40-50):(40-50):(0-10). The low-polymerization-degree polyglucose provided by the present disclosure has an average polymerization degree of 6-8, a 5-hydroxymethylfurfural content of ≤0.01%, a color of ≤30, a sweet taste and no bitter taste of polyglucose.

### DETAILED DESCRIPTION OF EMBODIMENTS

While certain examples of the present disclosure, it should be understood that the present disclosure may be embodied in various forms and should not be construed as being limited to the examples set forth herein. On the contrary, these examples are provided for a more complete and thorough understanding of the present disclosure. It should be understood that the examples of the present disclosure are for illustrative purposes only and are not intended to limit the scope of the present disclosure.

It should be understood that various steps recited in the method embodiments of the present application may be carried out in parallel by “and/or”. In addition, the method embodiments may include additional steps and/or exclude the steps shown. The scope of the present application is not limited in this respect.

For better understanding of the present disclosure, the following examples are given for further illustration of the present disclosure, but the present disclosure is not limited to the following examples.

The present disclosure provides a method for preparing low-polymerization-degree polyglucose, comprising the following steps:
mixing maltose, glucose and sorbitol, and then adding an acidic catalyst to carry out polymerization reaction to obtain a polymerization reaction product;
subjecting the polymerization reaction product to decolorization, ion exchange, concentration and drying sequentially to obtain low-polymerization-degree polyglucose;
the weight ratio of maltose, glucose and sorbitol is (40-50):(40-50):(0-10).

According to the present disclosure, maltose, glucose and sorbitol are mixed and then subjected to polymerization reaction to obtain a polymerization reaction product. The maltose added is a disaccharide, has a greater molecular weight compared with glucose as a substrate, is more favorable for controlling the polymerization degree, and makes it possible to complete the polymerization reaction at a lower temperature in a shorter time, so that the polyglucose prepared has a low and uniform polymerization degree. In addition, the Maillard reaction caused by long-time high-temperature polymerization is reduced, the 5-hydroxymethylfurfural content is lowered, and the obtained polyglucose product has a lower color, and does not produce bitter taste.

In the present disclosure, the weight ratio of maltose, glucose and sorbitol is preferably (40-50):(40-50):(0-10), more preferably (43-45):(45-48):(5-8). The control of the above weight ratio is beneficial to the polymerization reaction of the saccharides in a more proper ratio, and the proportion of maltose in the above ratio range is also beneficial to reducing the formation of 5-hydroxymethylfurfural, thereby reducing the product color. Meanwhile, under the action of the catalyst and sorbitol, the polyglucose with a polymerization degree that is more easily controlled to a lower value and uniform is obtained.

The acidic catalyst is citric acid or phosphoric acid. The polymerization reaction is preferably carried out under vacuum conditions, with a vacuum degree of preferably-0.085 to −0.1 MPa, and more preferably −0.09 MPa. The temperature of the polymerization reaction is preferably 120° C.-140° C., and more preferably 125° C.-135° C. The time of the polymerization reaction is preferably 60 min-120 min, more preferably 80-100 min, and most preferably 90 min-95 min.

The acidic catalyst mainly provides an acidic environment for the polymerization reaction, and thus strong and weak acids commonly used in the food field may be used in the present application. In certain embodiments, the acidic catalyst includes, but is not limited to, citric acid, phosphoric acid, hydrochloric acid, nitric acid, oxalic acid, malic acid, fumaric acid, acetic acid or lactic acid, and preferably the acidic catalyst is citric acid or phosphoric acid. For the amount of the catalyst added, a reference may be made to the amount of catalyst used in traditional high-temperature and high-pressure reaction, and in certain embodiments the amount of the acidic catalyst is 0.5% to 2% by weight relative to the weight of the reaction substrate (maltose, glucose and sorbitol).

In certain embodiments, the polymerization reaction is preferably carried out under vacuum conditions, with a vacuum degree of preferably −0.085 MPa to −0.1 MPa, and more preferably −0.09 MPa. The reaction carried out under vacuum conditions is more conducive to achieving the temperature required by the polymerization reaction, making the polymerization reaction carry out more uniformly and thus more helpful in controlling the polymerization degree of the prepared polyglucose.

When the raw materials are used for the polymerization reaction, the temperature required for the polymerization reaction is obviously reduced compared with the temperature of traditional high-temperature high-pressure reaction. In certain embodiments, the temperature of the polymerization reaction is preferably 120° C.-140° C., and more preferably 125° C.-135° C. By carrying out the polymerization reaction at the temperature, which is obviously reduced compared with the temperature of traditional process, it is more effective to avoid the problems that the Maillard reaction is not easy to control due to overhigh temperature, and the formation of 5-hydroxymethylfurfural is easy to occur, which may result in the polyglucose product with high color and bitter taste; meanwhile, it is also possible to avoid incomplete polymerization reaction caused by overlow temperature, which may result in a large amount of residual maltose and glucose, and low yield of polyglucose.

In certain embodiments, the time of the polymerization reaction is preferably 60 min-120 min, more preferably 80 min-100 min, and most preferably 90 min-95 min, within the above range, the yield of the low-polymerization-degree polyglucose increases with the increase of the polymerization reaction time, but the yield increase is not significant after 120 min.

In the present disclosure, after obtaining a polymerization reaction product, the polymerization reaction product is subjected to decolorization, ion exchange, concentration and drying sequentially to obtain low-polymerization-degree polyglucose. The methods for decolorization, ion exchange, concentration and drying are not particularly limited in the present disclosure. The methods well known to those skilled in the art may be selected.

According to the present disclosure, maltose, glucose and sorbitol are mixed according to a certain ratio, in place of glucose raw material in traditional process, and the polymerization is carried out at a lower temperature under high vacuum, so that the controllability of the polymerization degree of polyglucose is realized, and the obtained product is featured with low average polymerization degree, nearly colorless, low 5-hydroxymethylfurfural content, and no unpleasant bitter taste of traditional polyglucose product.

The present disclosure also provides low-polymerization-degree polyglucose prepared by the above method, wherein the low-polymerization-degree polyglucose has an average polymerization degree of 6-8, a 5-hydroxymethylfurfural content of ≤0.01%, a color of ≤30, a sweet taste and no bitter taste of polyglucose.

The measurement methods for DE value (all reducing sugars in the saccharification solution are calculated as glucose, and the percentage thereof relative to dry matter is called DE value), color, and 5-hydroxymethylfurfural content in various examples and comparative examples are as follows: 6.3 in GB/T 20882.2-2021, 6.6 in GB/T 20882.4-2021, and Appendix A.6 in GB 25541-2010.

### EXAMPLE 1

Maltose, glucose and sorbitol were mixed in a weight ratio of 40:50:10 as raw materials, 1% citric acid was added, and the resulting mixture was reacted under the conditions of −0.085 MPa and 120° C. for 90 min. After dissolution, conventional decolorization, centrifugal exchange, concentration, and drying were carried out to obtain a polyglucose product with a DE value of 17.5%, an average polymerization degree of 6.2, a color of 15, a 5-hydroxymethylfurfural content of 0.008%, a sweet taste, and no bitter taste.

### EXAMPLE 2

Maltose, glucose and sorbitol were mixed in a weight ratio of 50:40:10 as raw materials, 1% citric acid was added, and the resulting mixture was reacted under the conditions of −0.1 MPa and 140° C. for 60 min. After dissolution, conventional decolorization, centrifugal exchange, concentration, and drying were carried out to obtain a polyglucose product with a DE value of 15%, an average polymerization degree of 6.5, a color of 18, a 5-hydroxymethylfurfural content of 0.009%, a sweet taste, and no bitter taste.

### EXAMPLE 3

Maltose and glucose were mixed in a weight ratio of 50:50 as raw materials, 1% citric acid was added, and the resulting mixture was reacted under the conditions of −0.09 MPa and 135° C. for 120 min. After dissolution, conventional decolorization, centrifugal exchange, concentration, and drying were carried out to obtain a polyglucose product with a DE value of 12.5%, an average polymerization degree of 7.9, a color of 23, a 5-hydroxymethylfurfural content of 0.0095%, a sweet taste, and no bitter taste.

### EXAMPLE 4

Maltose, glucose and sorbitol were mixed in a weight ratio of 40:50:10 as raw materials, 0.5% phosphoric acid was added, and the resulting mixture was reacted under the conditions of −0.085 MPa and 120° C. for 90 min. After dissolution, conventional decolorization, centrifugal exchange, concentration, and drying were carried out to obtain a polyglucose product with a DE value of 13.8%, an average polymerization degree of 6.5, a color of 20, a 5-hydroxymethylfurfural content of 0.0089%, a sweet taste, and no bitter taste.

### EXAMPLE 5

Maltose, glucose and sorbitol were mixed in a weight ratio of 40:50:10 as raw materials, 0.2% hydrochloric acid was added, and the resulting mixture was reacted under the conditions of −0.085 MPa and 120° C. for 90 min. After dissolution, conventional decolorization, centrifugal exchange, concentration, and drying were carried out to obtain a polyglucose product with a DE value of 11.2%, an average polymerization degree of 7.6, a color of 15, a 5-hydroxymethylfurfural content of 0.0085%, a sweet taste, and no bitter taste.

### COMPARATIVE EXAMPLE 1

Glucose and sorbitol were mixed in a weight ratio of 90:10 as raw materials, 1% citric acid was added, and the resulting mixture was reacted under the conditions of −0.1 MPa and 160° C. for 90 min. After dissolution, conventional decolorization, centrifugal exchange, concentration, and drying were carried out to obtain a polyglucose product with a DE value of 6.5%, an average polymerization degree of 15.3, a color of 200, a 5-hydroxymethylfurfural content of 0.048%, and an obvious bitter taste.

### COMPARATIVE EXAMPLE 2

Glucose and sorbitol were mixed in a weight ratio of 90:10 as raw materials, 1% citric acid was added, and the resulting mixture was reacted under the conditions of −0.1 MPa and 140° C. for 60 min. After dissolution, conventional decolorization, centrifugal exchange, concentration, and drying were carried out to obtain a polyglucose product with a DE value of 8.2%, an average polymerization degree of 12.2, a color of 150, a 5-hydroxymethylfurfural content of 0.045%, and a bitter taste.

### COMPARATIVE EXAMPLE 3

Maltodextrin (starch hydrolysate), glucose and sorbitol were mixed in a weight ratio of 50:40:10 as raw materials, 1% citric acid was added, and the resulting mixture was reacted under the conditions of −0.1 MPa and 140° C. for 60 min. After dissolution, conventional decolorization, centrifugal exchange, concentration, and drying were carried out to obtain a polyglucose product with a DE value of 7%, an average polymerization degree of 14.2, a color of 600, a 5-hydroxymethylfurfural content of 0.45%, an obvious bitter taste, and a strong caramel taste.

### COMPARATIVE EXAMPLE 4

Maltose, glucose and sorbitol were mixed in a weight ratio of 30:60:10 as raw materials, 1% citric acid was added, and the resulting mixture was reacted under the conditions of −0.085 MPa and 120° C. for 90 min. After dissolution, conventional decolorization, centrifugal exchange, concentration, and drying were carried out to obtain a polyglucose product with a DE value of 7.3%, an average polymerization degree of 13.5, a color of 300, a 5-hydroxymethylfurfural content of 0.62%, an obvious bitter taste, and a strong caramel taste.

### COMPARATIVE EXAMPLE 5

Maltose, glucose and sorbitol were mixed in a weight ratio of 60:30:10 as raw materials, 1% citric acid was added, and the resulting mixture was reacted under the conditions of −0.085 MPa and 120° C. for 90 min. After dissolution, conventional decolorization, centrifugal exchange, concentration, and drying were carried out to obtain a polyglucose product with a DE value of 6.4%, an average polymerization degree of 14.8, a color of 420, a 5-hydroxymethylfurfural content of 0.25%, an obvious bitter taste, and a strong caramel taste.

The foregoing are only preferred embodiments of the present disclosure, and it should be noted that, for those skilled in the art, various modifications and amendments can be made without departing from the principle of the present disclosure, and these modifications and amendments should also be considered as the scope of protection of the present disclosure.

The foregoing description are only exemplary of the preferred embodiments of the present disclosure and illustrative of the principle of the technology employed. It will be appreciated by those skilled in the art that the scope of the disclosure herein is not limited to the technical solutions resulted from particular combinations of the above-mentioned technical features, but also encompasses, without departing from the spirit of the present disclosure, other technical solutions resulted from any combination of the above-mentioned technical features or equivalents thereof, for example, the technical solutions resulted from replacing the above-mentioned technical features with (but not limited to) the technical features having similar functions disclosed in the present disclosure.

1. A method for preparing low-polymerization-degree polyglucose, wherein the method comprises the following steps:
mixing maltose, glucose and sorbitol, and then adding an acidic catalyst to carry out polymerization reaction to obtain a polymerization reaction product;
subjecting the polymerization reaction product to decolorization, ion exchange, concentration and drying sequentially to obtain the low-polymerization-degree polyglucose;
the weight ratio of maltose, glucose and sorbitol is (40-50):(40-50):(0-10).

2. The method as claimed in claim 1, wherein the polymerization reaction is carried out under vacuum conditions, with a vacuum degree of −0.1 MPa to −0.085 MPa.

3. The method as claimed in claim 1, wherein the temperature of the polymerization reaction is 120° C.-140° C., and the time of the polymerization reaction is 60 min-120 min.

4. The method as claimed in claim 1, wherein the acidic catalyst is citric acid, phosphoric acid, hydrochloric acid, nitric acid, oxalic acid, malic acid, fumaric acid, acetic acid or lactic acid.

5. Low-polymerization-degree polyglucose prepared by the method as claimed in claim 1, wherein the low-polymerization-degree polyglucose has an average polymerization degree of 6-8, a 5-hydroxymethylfurfural content of ≤0.01%, a color of ≤30, a sweet taste and no bitter taste of polyglucose.

6. The method as claimed in claim 2, wherein the temperature of the polymerization reaction is 120° C.-140° C., and the time of the polymerization reaction is 60 min-120 min.

7. The method as claimed in claim 1, wherein the temperature of the polymerization reaction is 125° C.-135° C.

8. The method as claimed in claim 1, wherein the time of the polymerization reaction is 80 min-100 min.

9. The method as claimed in claim 2, wherein the acidic catalyst is citric acid, phosphoric acid, hydrochloric acid, nitric acid, oxalic acid, malic acid, fumaric acid, acetic acid or lactic acid.

10. The method as claimed in claim 3, wherein the acidic catalyst is citric acid, phosphoric acid, hydrochloric acid, nitric acid, oxalic acid, malic acid, fumaric acid, acetic acid or lactic acid.

11. The method as claimed in claim 6, wherein the acidic catalyst is citric acid, phosphoric acid, hydrochloric acid, nitric acid, oxalic acid, malic acid, fumaric acid, acetic acid or lactic acid.

12. The method as claimed in claim 7, wherein the acidic catalyst is citric acid, phosphoric acid, hydrochloric acid, nitric acid, oxalic acid, malic acid, fumaric acid, acetic acid or lactic acid.

13. The method as claimed in claim 8, wherein the acidic catalyst is citric acid, phosphoric acid, hydrochloric acid, nitric acid, oxalic acid, malic acid, fumaric acid, acetic acid or lactic acid.

14. Low-polymerization-degree polyglucose, wherein the low-polymerization-degree polyglucose has an average polymerization degree of 6-8, a 5-hydroxymethylfurfural content of ≤0.01%, a color of ≤30, a sweet taste and no bitter taste of polyglucose.
